(19) United States
(12) Patent Application Publication
(10) Pub. No.: US 2020/0328018 A1
(43) Pub. Date: Oct. 15, 2020

(54) ELECTROMAGNETIC ACTUATOR AND METHOD FOR MANUFACTURING SAME

(71) Applicant: Mitsubishi Electric Corporation, Tokyo (JP)

(72) Inventors: Satoshi TESEN, Tokyo (JP); Hitoshi YOSHIZUMI, Tokyo (JP)

(73) Assignee: Mitsubishi Electric Corporation, Tokyo (JP)

(21) Appl. No.: 16/088,969

(22) PCT Filed: May 16, 2016
(86) PCT No.: PCT/JP2016/064467

§ 371 Date: Sep. 27, 2018

(51) Int. Cl. H01F 7/121; H01F 7/126; H01F 7/16; H01F 7/08

(52) U.S. Cl. CPC H01F 7/121; H01F 7/126; H01F 2007/1692; H01F 7/081; H01F 7/16

(57) ABSTRACT

An electromagnetic actuator 1 includes divisional cores (5a1 and 5a2), divisional cores (5b1 and 5b2) , a first coil unit (3A), a second coil unit (3B), a first movable unit (11a), a second movable unit (11b), and a casing (2). The casing (2) includes a magnetic material and surrounds the first coil unit (3A) and the second coil unit (3B) integrally.

### TECHNICAL FIELD

The present invention relates to an electromagnetic actuator including multiple linearly movable units and a method for manufacturing such an electromagnetic actuator.

### BACKGROUND ART

A typical traditional device including multiple linearly movable units is a solenoid device disclosed, for example, in Patent Literature 1. This solenoid device includes a first electromagnetic coil, a second electromagnetic coil, a first plunger, a second plunger, a first fixing core, a second fixing core, a first coupling yoke, a second coupling yoke, a core-connecting yoke, and a second coupling unit.

The first and second electromagnetic coils conduct electricity and thereby generate magnetic fluxes.

The first and second plungers are linearly movable units. The first plunger is linearly moved in response to electric conduction to the first electromagnetic coil, and the second plunger is linearly moved in response to electric conduction to the second electromagnetic coil.

The first fixing core is disposed at a position facing the first plunger in the moving direction of the first plunger. The second fixing core is disposed at a position facing the second plunger in the moving direction of the second plunger.

The first coupling yoke couples the first plunger to the second plunger.

The second coupling yoke is disposed between the first electromagnetic coil and the second electromagnetic coil and couples the first plunger to the second fixing core.

One end of the second coupling unit is coupled to the end of the first coupling yoke adjacent to the second plunger, and the other end of the second coupling unit is coupled to the end of the second coupling yoke adjacent to the second fixing core. Thus, the second electromagnetic coil is surrounded by the first coupling yoke, the second coupling yoke, and the second coupling unit.

The core-connecting yoke is coupled to the first fixing core and to the end of the second coupling yoke adjacent to the first plunger. Thus, the first electromagnetic coil is surrounded by the core-connecting yoke and the second coupling yoke.

A cutout is provided between the end of the core-connecting yoke adjacent to the first fixing core and the portion of the second coupling yoke connected to the second fixing core. The cutout restricts the flow of the magnetic flux between these.

### CITATION LIST

### Patent Literature

[PLT 1]

Japanese Patent Application Publication No. 2014-103219

### SUMMARY OF INVENTION

### Technical Problem

The electromagnetic force driving the plunger increases as the circumference of a magnetic circuit, in which the magnetic flux generated by electric conduction in the coil flows, decreases and as the cross-sectional area of a component through which the magnetic flux passes increases.

The solenoid device disclosed in Patent Literature 1 includes a magnetic circuit where the magnetic flux passes through the first and second coupling yokes.

Unfortunately, in the solenoid device disclosed in Patent Literature 1, the first electromagnetic coil and the second electromagnetic coil are each separately surrounded by the yokes, and the cutout is provided between the second coupling yoke surrounding the second electromagnetic coil and the core-connecting yoke surrounding the first electromagnetic coil.

Thus, a magnetic circuit which includes the core-connecting yoke and the second coupling yoke and has a short path for the magnetic flux cannot be made, and hence the magnetic efficiency cannot be enhanced.

For example, the magnetic flux generated by electric conduction in only the first electromagnetic coil flows to the first plunger through the first coupling yoke. Of the magnetic flux, a flux component flowing to the core-connecting yoke surrounding the first electromagnetic coil is restrained from flowing to the second coupling yoke adjacent to the second electromagnetic coil by air in the cutout that serves as a magnetic resistance.

An object of the present invention, which has been made to solve the above mentioned problem, is to provide an electromagnetic actuator capable of enhancing the magnetic efficiency and a method for manufacturing such an electromagnetic actuator.

### Solution To Problem

An electromagnetic actuator according to the present invention includes: multiple cores; multiple coil units; multiple movable units; and a casing. The multiple cores each include a magnetic material. The multiple coil units are provided around the outer circumferences of the respective cores. The multiple movable units move in the axial directions of the respective cores by thrust generated by electric conduction to the respective coil units. The casing includes a magnetic material and surrounds the multiple coil units integrally.

### Advantageous Effects Of Invention

According to the present invention, the casing including a magnetic material surrounds the multiple coil units integrally. Thus, also a portion of the casing which is around the outer circumference of not energized coil unit can be used for a flux path, through which a magnetic flux generated by electric conduction to part of the coil units passes. As a result of this, the cross-sectional area of the flux path increases, and thus the magnetic efficiency can be enhanced.

### BRIEF DESCRIPTION OF DRAWING

FIG. 1 is a top view of an electromagnetic actuator according to Embodiment 1 of the present invention.

FIG. 2 is a cross-sectional arrow view taken along line A-A in FIG. 1 of the electromagnetic actuator according to Embodiment 1.

FIG. 3 is a cross-sectional arrow view taken along line B-B in FIG. 2 of the electromagnetic actuator according to Embodiment 1.

FIG. 4 is a cross-sectional view of a traditional electromagnetic actuator.

FIG. 5 is a cross-sectional view illustrating magnetic circuits in the electromagnetic actuator according to Embodiment 1.

FIG. 6 is a cross-sectional view of an electromagnetic actuator according to Embodiment 2 of the present invention.

FIG. 7 is a top view of a material of a casing in Embodiment 2.

FIG. 8 is a top view of the casing in Embodiment 2.

FIG. 9 is a cross-sectional view of the main part of an electromagnetic actuator, illustrating a method for manufacturing the electromagnetic actuator according to Embodiment 3 of the present invention.

FIG. 10 is a top view of the electromagnetic actuator in the present invention.

### DESCRIPTION OF EMBODIMENTS

Hereafter, in order to explain the present invention in more detail, embodiments of the present invention will be described with reference to the accompanying drawings.

### Embodiment 1

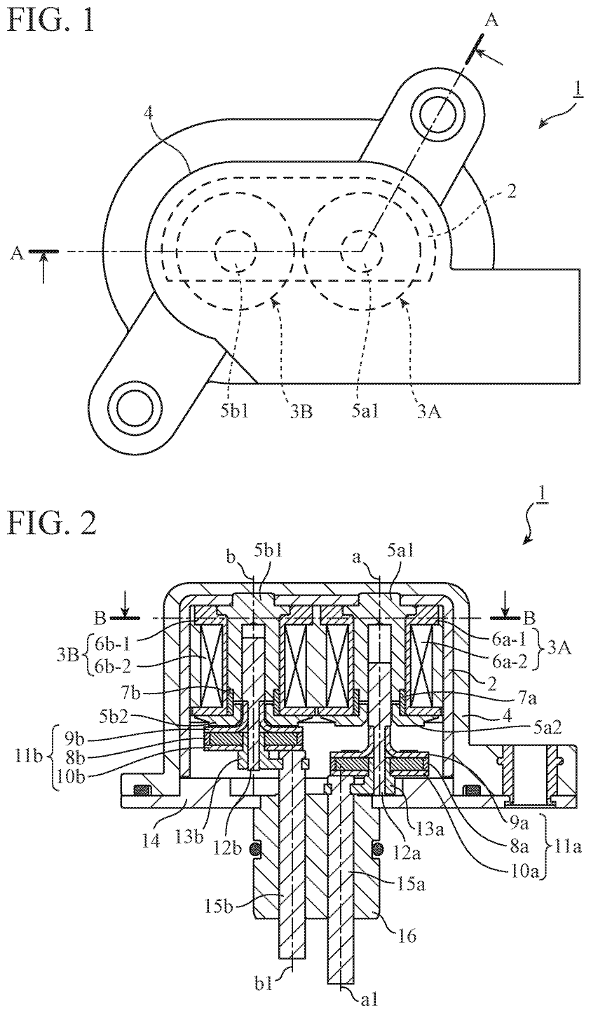

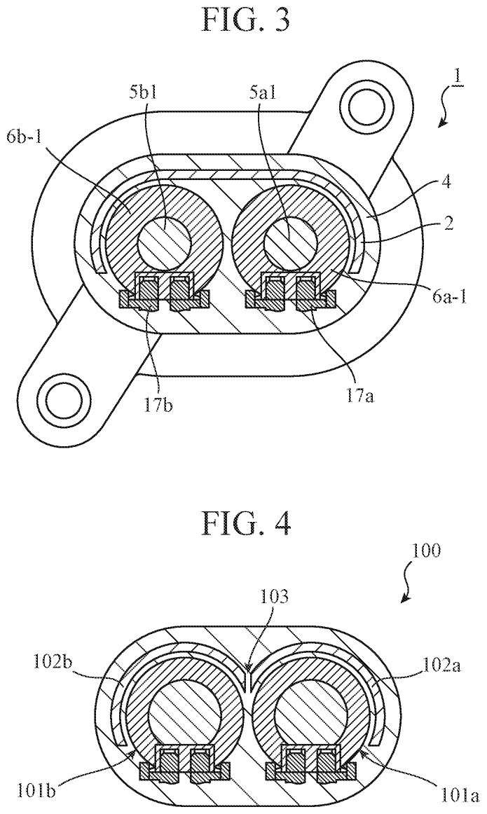

FIG. 1 is a top view of an electromagnetic actuator 1 according to Embodiment 1 of the present invention. FIG. 2 is a cross-sectional arrow view taken along line A-A in FIG. 1 of the electromagnetic actuator 1. FIG. 3 is a cross-sectional arrow view taken along line B-B in FIG. 2 of the electromagnetic actuator 1.

The electromagnetic actuator 1 includes a casing 2 accommodating a first coil unit 3A and a second coil unit 3B as drawn by dashed lines in FIG. 1. The casing 2, the first coil unit 3A, and the second coil unit 3B are integrated by resin molding with a resin 4.

The casing 2 is a box including a magnetic material and surrounds the first coil unit 3A and the second coil unit 3B integrally, as illustrated in FIG. 3.

The first and second coil units 3A and 3B are coil assemblies provided side by side in the casing 2. The first coil unit 3A includes a coil 6a-2 that is formed by winding a wire on a spool 6a-1 and then connected to an electrode 17a illustrated in FIG. 3. Similarly, the second coil unit 3B includes a coil 6b-2 that is formed by winding a wire on a spool 6b-1 and then connected to another electrode 17b illustrated in FIG. 3.

As illustrated in FIG. 2, divisional cores 5a1 and 5a2 are provided side by side along an axis a. The divisional core 5a1 is provided on the inner circumference of the spool 6a-1 whereas the divisional core 5a2 is provided adjacent to a first movable unit 11a. A bush 7a is a ring member mounted on a portion where the divisional core 5a1 and the divisional core 5a2 are facing each other, and holds the divisional cores 5a1.

Similarly, the divisional core 5b1 and the divisional core 5b2 are provided side by side along an axis b. A bush 7b holds the divisional cores 5b1 and 5b2.

The divisional cores 5a1 and 5b1 are bottomed cylindrical members each including a magnetic material. The divisional core 5a1 has a hole along the axis a, and the hole is open toward the divisional core 5a2. The divisional core 5b1 has a hole along the axis b, and the hole is open toward the divisional core 5b2.

The divisional cores 5a2 and 5b2 are members each including a magnetic material and having a cylindrical portion and a flange extending radially outward from an end of the cylindrical portion. The cylindrical portion of the divisional core 5a2 has a through-hole along the axis a and is provided with the flange at an end adjacent to the first movable unit 11a. The cylindrical portion of the divisional core 5b2 also has a through-hole along the axis b and is provided with the flange at an end adjacent to a second movable unit 11b.

As illustrated in FIG. 2, the first movable unit 11a includes a permanent magnet 8a, a plate 9a, and a plate 10a and reciprocally moves between the divisional core 5a2 and a housing 14 in the direction of the axis a.

Similarly, the second movable unit 11b includes a permanent magnet 8b, a plate 9b, and a plate 10b and reciprocally moves between the divisional core 5b2 and the housing 14 in the direction of the axis b.

The permanent magnet 8a having a disk shape includes a portion magnetized to the north pole adjacent to the divisional core 5a2, a portion magnetized to the south pole remote from the divisional core 5a2, and a through-hole in the center. Similarly, the permanent magnet 8b having a disk shape includes a portion magnetized to the north pole adjacent to the divisional core 5b2, a portion magnetized to the south pole remote from the divisional core 5b2, and a through-hole in the center. In the first movable unit 11a, the permanent magnet 8a is held between the plate 9a and the plate 10a. The plate 9a is fixed to the face of the permanent magnet 8a adjacent to the divisional core 5a2. The plate 10a is fixed to the face of the permanent magnet 8a remote from the divisional core 5a2. Similarly, the permanent magnet 8b is held between the plate 9b and the plate 10b. It should be noted that the directions of the magnetic poles of the permanent magnets 8a and 8b may be different from those described above depending on purposes of the electromagnetic actuator.

The plate 9a and the plate 9b each include a magnetic material and have a cylindrical portion and a flange extending radially outward from an end of the cylindrical portion.

The cylindrical portion of the plate 9a has a through-hole along the axis a and is provided with the flange at an end adjacent to the permanent magnet 8a. Similarly, the cylindrical portion of the plate 9b also has a through hole along the axis b and is provided with the flange at an end adjacent to the permanent magnet 8b.

The cylindrical portion of the plate 9a can be inserted into the hole in the divisional core 5a2 along with movement of the first movable unit 11a. The cylindrical portion of the plate 9b can be inserted into the hole in the divisional core 5b2 along with movement of the second movable unit 11b.

The plate 10a and the plate 10b each include a magnetic material and have a through-hole in the center.

A shaft 12a is a bar inserted into the hole in the divisional core 5a1 and the hole in the divisional core 5a2. Of the bar, the section remote from the output side has a larger diameter than the section adjacent to the output side. The bar section remote from the output side is inserted into the hole in the divisional core 5a1 and the hole in the divisional core 5a2. Similarly, a shaft 12b is a bar whose section remote from the output side has a larger diameter, and this bar section remote from the output side is inserted into the hole in the divisional core 5b1 and the hole in the divisional core 5b2.

A joint 13a has a plate-like body. A first pin 15a is mounted at one end of the body, and a cylindrical portion which has a through-hole along the axis a is provided at the other end of the body.

Similarly, a joint 13b also has a plate-like body. A second pin 15b is mounted at one end of the body, and a cylindrical portion which has a through-hole along the axis b is provided at the other end of the body.

The cylindrical portion of the joint 13a is fitted into the hole in the plate 10a and the hole in the permanent magnet 8a. Similarly, the cylindrical portion of the joint 13b is also fitted into the hole in the plate 10b and the hole in the permanent magnet 8b.

As illustrated in FIG. 2, the bar section of the shaft 12a adjacent to the output side is inserted into the hole in the cylindrical portion of the plate 9a and further into the hole in the cylindrical portion of the joint 13a and is fixed.

Similarly, the bar section of the shaft 12b adjacent to the output side is inserted into the hole in the cylindrical portion of the plate 9b and further into the hole in the cylindrical portion of the joint 13b and is fixed.

Each of the shafts 12a and 12b is fixed, for example, by welding after insertion into the holes or by press fitting into the holes.

As illustrated in FIG. 2, the first and second pins 15a and 15b are bars and are inserted into respective holes in a boss 16 mounted to the housing 14.

The axis a1 of the first pin 15a is provided parallel to the axis a of the first movable unit 11a and is shifted toward the second pin 15b. Similarly, the axis b1 of the second pin 15b is provided parallel to the axis b of the second movable unit 11b and is shifted toward the first pin 15a.

In other words, the interval between the first pin 15a and the second pin 15b is narrower than the interval between the first movable unit 11a and the second movable unit 11b.

If the interval between the axis a of the first movable unit 11a and the axis a1 of the first pin 15a is enlarged, the first pin 15a is likely to be inclined to the axis a of the first movable unit 11a.

In this case, a so-called twist readily occurs, which causes the first pin 15a to come into contact with the hole in the boss 16 to restrain the linear movement. Thus, the interval between the axis a of the first movable unit 11a and the axis a1 of the first pin 15a is preferably reduced as much as possible.

Meanwhile, the interval between the first pin 15a and the second pin 15b depends on purposes of the electromagnetic actuator 1. Thus, in the case of a purpose requiring a narrow interval between the first pin 15a and the second pin 15b, the first coil unit 3A should be provided close to the second coil unit 3B as much as possible in order to shorten the interval between the axis a of the first movable unit 11a and the axis a1 of the first pin 15a.

A possible approach for providing the first coil unit close to the second coil unit with the first coil unit and the second coil unit surrounded by separate casings is to reduce the radial dimensions of the first coil unit and the second coil unit to allow them to be close.

For example, the output of a coil does not vary as long as applied current is constant and total number of windings does not change. Thus, a decrease in layers of windings and an increase in windings per layer can reduce the radial dimensions of the first coil unit and the second coil unit.

A reduction in the radial dimension in such an approach, however, always enlarges the axial lengths of the first coil unit and the second coil unit. Such enlarged dimensions unfavorably restrict mounting of an electromagnetic actuator.

Thus, in a traditional electromagnetic actuator 100 illustrated in FIG. 4, no casing is provided between a first coil unit 101a and a second coil unit 101b, in order to closely provide the first coil unit 101a and the second coil unit 101b without an increase in axial length. In this configuration, the first coil unit 101a is surrounded by a first casing 102a, and the second coil unit 101b is surrounded by a second casing 102b. A cutout 103 is provided between the first casing 102a and the second casing 102b.

The cutout 103 between the first casing 102a and the second casing 102b, however, restricts the flow of the magnetic flux generated by electric conduction in coils between the first casing 102a and the second casing 102b because air in the cutout 103 serves as a magnetic resistance. Thus, a magnetic circuit which includes the first casing 102a and the second casing 102b and has a large cross-sectional area is not provided, and hence the magnetic efficiency cannot be enhanced.

In contrast, in the electromagnetic actuator 1 according to Embodiment 1, the first coil unit 3A is provided close to the second coil unit 3B and the single casing 2 is provided so as to surround the first coil unit 3A and the second coil unit 3B integrally, as illustrated in FIG. 3.

In such a configuration, a magnetic circuit which includes the casing 2 and has a large cross-sectional area can be provided without separate casings individually surrounding the first coil unit 3A and the second coil unit 3B, and thus the magnetic efficiency can be enhanced.

Since separate casings for the first and second coil units 3A and 3B are not required, the number of components can be reduced.

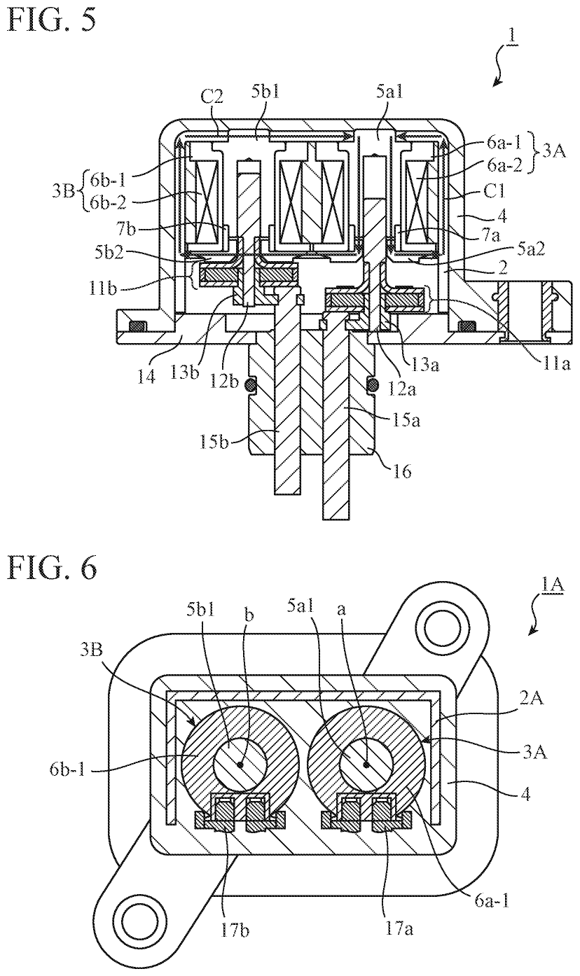

For example, when electricity is conducted to the coil 6a-2 in the first coil unit 3A, a magnetic flux generated by the coil 6a-2 flows in a magnetic circuit C1 where the magnetic flux flows from the casing 2 through the divisional cores 5a1 and 5a2 and returns to the casing 2, as illustrated in FIG. 5.

Furthermore, the magnetic flux generated by the coil 6a-2 also flows in a magnetic circuit C2 where the magnetic flux flows from the divisional core 5a1 through the divisional core 5a2, the divisional core 5b2 adjacent to the second coil unit 3B, and the casing 2 and returns to the divisional core 5a1. In this way, the magnetic flux generated by the coil 6a-2 can flow not only around the first coil unit 3A but also in a portion of the casing 2 which is adjacent to a coil to which no electricity is conducted.

As described above, the electromagnetic actuator 1 according to Embodiment 1 includes the divisional cores 5a1 and 5a2, the divisional cores 5b1 and 5b2, the first coil unit 3A, the second coil unit 3B, the first movable unit 11a, the second movable unit 11b, and the casing 2. In this configuration, the casing 2 includes a magnetic material and surrounds the first coil unit 3A and the second coil unit 3B integrally. Thus, the magnetic circuit C2 which includes the casing 2 and has a large cross-sectional area can be provided, and thus the magnetic efficiency can be enhanced.

Since the separate casings for the first coil unit 3A and the second coil unit 3B are not required, the number of components can be reduced.

### Embodiment 2

FIG. 6 is a cross-sectional view taken along a line in the same position as that of line B-B in FIG. 2 of an electromagnetic actuator 1A according to Embodiment 2 of the present invention.

As illustrated in FIG. 6, a first coil unit 3A and a second coil unit 3B are provided so that an axis a is parallel to and as close as possible to an axis b, as in the electromagnetic actuator 1 according to Embodiment 1. A casing 2A includes a magnetic material and surrounds the first coil unit 3A and the second coil unit 3B.

The cross-section of the casing 2A cut in the direction orthogonal to the axes a and b has a rectangular shape with one open side, as illustrated in FIG. 6. In other words, the casing 2A has six faces and two of the faces are open at the extraction side of electrodes 17a and 17b and output side.

The casing 2 has a curved face around the first coil unit 3A and the second coil unit 3B to extend along the outer circumferences of the first coil unit 3A and the second coil unit 3B.

In contrast, the casing 2A just surrounds the first coil unit 3A and the second coil unit 3B by flat faces and can be thus made by a simple process.

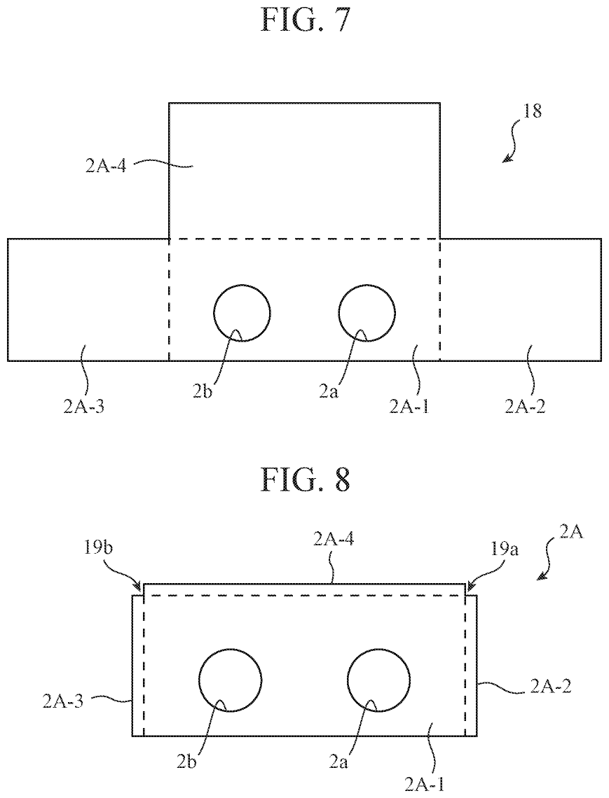

For example, the casing 2A can be made by bending a flat magnetic material 18 which is illustrated in FIG. 7. The flat magnetic material 18 has a T shape and includes a body 2A-1 with holes 2a and 2b, side pieces 2A-2 and 2A-3 extending from the body 2A-1 to the left side and the right side thereof, and a longitudinal piece 2A-4 extending orthogonally to the extension directions of the side pieces 2A-2 and 2A-3. Ends of a divisional core 5a1 and a divisional core 5b1 are fitted into the respective holes 2a and 2b.

As illustrated in FIG. 8, the casing 2A can be made by a simple process involving just bending the longitudinal piece 2A-4 and the side pieces 2A-2 and 2A-3 of the flat magnetic material 18 in the same direction.

Such a simple process of making the casing 2A allows for low-cost manufacturing of the electromagnetic actuator 1A.

As illustrated in FIG. 8, however, when a gap is present between the side piece 2A-2 and the longitudinal piece 2A-4 at a corner 19a and a gap is present between the side piece 2A-3 and the longitudinal piece 2A-4 at a corner 19b, difficulty in the passage of magnetic fluxes occurs, which causes magnetic loss.

Thus, in the case where the casing 2A is produced from the flat magnetic material 18, the side piece 2A-2 and the longitudinal piece 2A-4 are preferably bent until they come into contact with each other at the corner 19a, and the side piece 2A-3 and the longitudinal piece 2A-4 are preferably bent until they come into contact with each other at the corner 19b.

As described above, in the electromagnetic actuator 1A according to Embodiment 2, the casing 2A has six faces, and two of the faces are open. In this configuration, the casing 2A is generated by bending the longitudinal piece 2A-4 and the both side pieces 2A-2 and 2A-3 of the flat magnetic material 18 having a T shape. Thus, the casing 2A can be made by a simple process.

### Embodiment 3

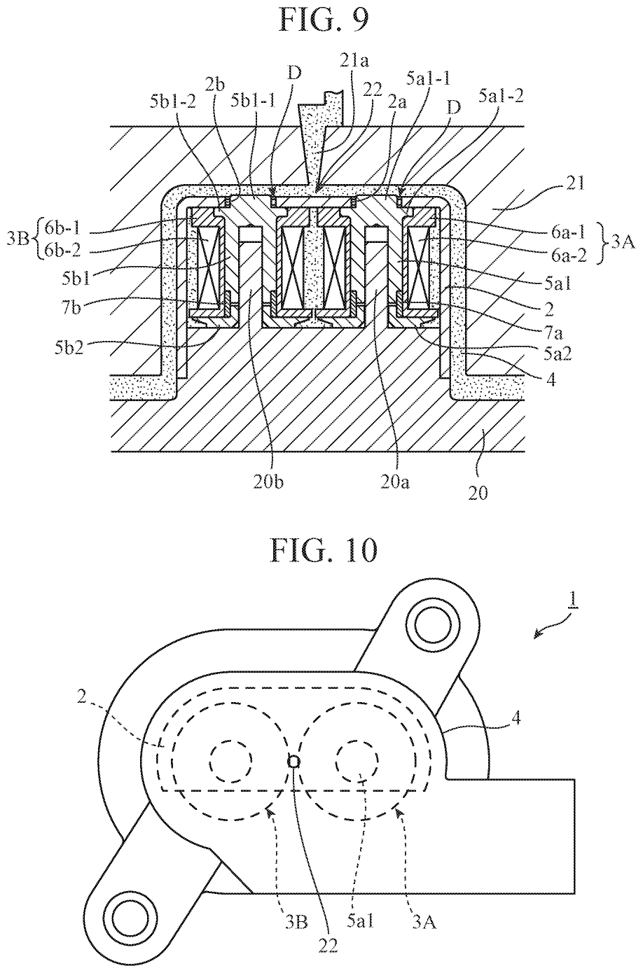

FIG. 9 is a cross-sectional view of the main part of an electromagnetic actuator 1, illustrating a method for manufacturing the electromagnetic actuator 1 according to Embodiment 3 of the present invention. FIG. 9 outlines a resin molding process among manufacturing processes of the electromagnetic actuator 1.

In the electromagnetic actuator 1, a stationary unit adjacent to a first movable unit 11a includes a casing 2, a first coil unit 3A, and divisional cores 5a1 and 5a2.

A stationary unit adjacent to a second movable unit 11b includes the casing 2, a second coil unit 3B, and divisional cores 5b1 and 5b2. These stationary units are integrated by resin molding with a resin 4.

In the resin molding, the resin 4 should be prevented from intruding into portions other than the stationary units to avoid generation of burrs. In this case, the dimensional precision is required for between a mold 20 and the inner diameter of the casing 2, between a pillar 20a in the mold 20 and the inner diameters of the divisional cores 5a1 and 5a2, and between a pillar 20b in the mold 20 and the inner diameters of the divisional cores 5b1 and 5b2.

Unfortunately, in the traditional resin molding, divisional cores are fixed to a casing, and then they are placed on a mold. Thus, when the pitch between an axis a and an axis b, which are the central axes of divisional cores, is not precise in dimension, it is impossible to place them on the mold.

In contrast, in the electromagnetic actuator 1 according to Embodiment 3, the approach of leaving the divisional cores unfixed to the casing is employed. The divisional cores 5a1 and 5b1 are placed on the mold 20 so that end portions 5a1-1 and 5b1-1 of the divisional cores 5a1 and 5b1 remote from the output side are inserted into the holes 2a and 2b in the casing 2, respectively, with clearance D. More specifically, the diameters of the end portions 5a1-1 and 5b1-1 are smaller than those of openings of the holes 2a and 2b.

In such a configuration, when the stationary units are placed on the mold 20, the clearance D absorbs the dimensional error between the mold 20 and the inner diameter of the casing 2; the clearance D absorbs the dimensional error between the pillar 20a in the mold 20 and the inner diameters of the divisional cores 5a1 and 5a2; and the dimensional error between the pillar 20b in the mold 20 and the inner diameters of the divisional cores 5b1 and 5b2. This enables the stationary units to be readily placed on the mold 20.

As illustrated in FIG. 9, the divisional cores 5a1 and 5b1 have flanges 5a1-2 and 5b1-2 around the end portions 5a1-1 and 5b1-1, respectively. When the stationary units are placed on the mold 20, the flange 5a1-2 comes into contact with the outer circumferential edge around the opening of the hole 2a and the flange 5b1-2 comes into contact with the outer circumferential edge around the opening of the hole 2b. In this state, a mold 21 is placed outside the casing 2.

The mold 21 has a single gate 21a for resin injection at a central position 22 between the first coil unit 3A and the second coil unit 3B neighboring each other, which are illustrated in FIG. 10.

After the mold 21 is mounted on the mold 20, the resin 4 is ejected from the gate 21a. The casing 2 is pressed against the flanges 5a1-2 and 5b1-2 by the molding pressure. Thereby, while the flange 5a1-2 is kept in contact with the outer circumferential edge around the opening of the hole 2a and the flange 5b1-2 is kept in contact with the outer circumferential edge around the opening of the hole 2b, resin molding is performed.

As stated above, the end portions 5a1-1 and 5b1-1 of the divisional cores 5a1 and 5b1 are inserted into the holes 2a and 2b, respectively, with the clearance D. The clearance D is an air gap between the end portion 5a1-1 or 5b1-1 and the hole 2a or 2b.

Even so, the flange 5a1-2 is in contact with the outer circumferential edge around the opening of the hole 2a and the flange 5b1-2 is in contact with the outer circumferential edge around the opening of the hole 2b. Magnetic fluxes thus flow through the flanges 5a1-2 and 5b1-2 to the casing 2 . A reduction in magnetic efficiency can be thereby restricted.

As described above, in the electromagnetic actuator 1 according to Embodiment 3, the end portions 5a1-1 and 5b1-1 of the divisional cores 5a1 and 5b1 remote from the output side are inserted into the holes 2a and 2b each provided in the casing 2 with the clearance D. Such a configuration allows for readily positioning of the stationary units relative to the mold 20.

In the electromagnetic actuator 1 according to Embodiment 3, the divisional cores 5a1 and 5b1 respectively have the flanges 5a1-2 and 5b1-2 that are inside the casing 2 and in contact with the outer circumferential edges around the openings of the holes 2a and 2b. In such a configuration, when the clearance D serves as a magnetic resistance, magnetic fluxes can flow through the flanges 5a1-2 and 5b1-2 to the casing 2, and thus a reduction in magnetic efficiency can be restricted.

A manufacturing method according to Embodiment 3 includes the steps of placing the stationary units into the molds 20 and 21; and molding the exterior of the casing 2, the first coil unit 3A, and the second coil unit 3B with the resin 4 ejected from the gate 21a provided in the mold 21.

For the first coil unit 3A and the second coil unit 3B, the end portions 5a1-1 and 5b1-1 of the divisional core 5a1 and 5b1 are inserted into the holes 2a and 2b, respectively, with the clearance D. The flanges 5a1-2 and 5b1-2 of the divisional cores 5a1 and 5b1 are mounted to the casing 2 so that the flanges 5a1-2 and 5b1-2 are inside casing 2 and in contact with the outer circumferential edges around the openings of the holes 2a and 2b. The gate 21a is provided at the central position 22 between the first coil unit 3A and the second coil unit 3B. As a result of such a configuration, the stationary units can be readily positioned relative to the mold 20, and a reduction in magnetic efficiency can be restricted.

In the case where three or more coil units are provided in the casing, multiple gates may be provided at positions on the mold 21 so that the casing is evenly pressed against the coil units by the ejected resin.

For example, in the case where the casing has a rectangular top, multiple gates are provided at positions on the mold 21 that correspond to the multiple positions along the diagonal lines on the top, in order to evenly press the top of the casing against the coil units by the resin.

Embodiments 1 to 3 include two coil units, namely the first coil unit 3A and the second coil unit 3B. Alternatively, the electromagnetic actuator according to the present invention may include three or more coil units.

For example, three or more coil units are provided so that their axes relative to each other are parallel, and the single casing surrounds all of the coil units. Such a configuration can also achieve the same effect as described above.

It should be noted that the present invention can include any combination of embodiments, or modifications or omission of any component in the embodiments within the scope of the present invention.

### Industrial Applicability

Because the electromagnetic actuator according to the present invention can enhance the magnetic efficiency, the electromagnetic actuator can be used in, for example, cam shifters in automobile engines.

### REFERENCE SIGNS LIST

1, 1A, 100 electromagnetic actuator
2, 2A casing
2A-1 body
2A-2, 2A-3 side piece
2A-4 longitudinal piece
2a, 2b hole
3A, 101a first coil unit
3B, 101b second coil unit
5a1, 5a2, 5b1, 5b2 divisional core
5a1-1, 5b1-1 end portion
5a1-2, 5b1-2 flange
6a-1, 6b-1 spool
6a-2, 6b-2 coil
7a, 7b bush
8a, 8b permanent magnet
9a, 9b, 10a, 10b plate
11a first movable unit
11b second movable unit
12a, 12b shaft
13a, 13b joint
14 housing
15a first pin
15b second pin
16 boss
17a, 17b electrode
18 flat magnetic material
19a, 19b corner
20, 21 mold
20a, 20b pillar
21a gate
22 central position
102a first casing
102b second casing
103 cutout

1-7. (canceled)

8. An electromagnetic actuator comprising:
multiple cores each including a magnetic material;
multiple coil units provided around outer circumferences of the respective cores;
multiple movable units for moving in axial directions of the respective cores by thrust generated by electric conduction to the respective coil units; and
a casing including a magnetic material and surrounding the multiple coil units integrally,
wherein an end portion of each of the cores remote from output side is inserted into a corresponding hole provided in the casing with clearance.

9. The electromagnetic actuator according to claim 8, wherein the casing has six faces, two of the faces being open.

10. The electromagnetic actuator according to claim 9, wherein the casing is generated by bending a longitudinal piece, a left side piece, and a right side piece of a flat magnetic material having a T shape.

11. The electromagnetic actuator according to claim 8, wherein each of the cores has a flange which is inside the casing and in contact with an outer circumferential edge around an opening of the corresponding hole.

12. A method for manufacturing an electromagnetic actuator, comprising:
placing multiple cores each including a magnetic material, multiple coil units provided around outer circumferences of the respective cores, and a casing including a magnetic material into a mold so that the casing surrounds the multiple coil units integrally; and
molding an exterior of the casing and the multiple coil units with a resin ejected from a gate provided in the mold, wherein
the multiple coil units are mounted to the casing so that an end portion of each of the cores remote from output side is inserted into a corresponding hole provided in the casing with clearance and a flange of each of the cores is inside the casing and in contact with an outer circumferential edge around an opening of the corresponding hole; and
the gate is provided at a position on the mold so that the casing is evenly pressed against the coil units by the ejected resin.

13. The method for manufacturing an electromagnetic actuator according to claim 12, wherein the gate on the mold is provided at a central position between the neighboring coil units.
